(19) United States
(12) Patent Application Publication
(10) Pub. No.: US 2026/0267811 A1
(43) Pub. Date: Sep. 10, 2026

(54) DIRECT MEMORY ACCESS (DMA) OVER SCALE-UP BACKEND NETWORK

(71) Applicant: MIPS Tech, LLC, San Jose, CA (US)

(72) Inventors: Prakash C. Jain, Fremont, CA (US); Durgesh Srivastava, Cupertino, CA (US)

(21) Appl. No.: 19/561,036

(22) Filed: Mar. 9, 2026

Related U.S. Application Data
(60) Provisional application No. 63/769,384, filed on Mar. 10, 2025.

(51) Int. Cl. G06F 13/28; G06F 9/50

(52) U.S. Cl. CPC G06F 13/28; G06F 9/5072; G06F 2213/28

(57) ABSTRACT

Disclosed is a data center backend network including compute clusters (CCs). Each CC includes a scale-up network, which includes a scale-up switch and a group of nodes. Each node can be a networked computer including, amongst other components, a scale-up network interface card (NIC) in communication with the scale-up switch. The NICs of the different nodes can each include a subsystems block including a network infrastructure subsystem configured to support scale-up operations across the scale-up network. Scale-up operations include, for example, memory access operations (such as conventional load and store operations and direct memory access (DMA) operations) between any two nodes using the scale-up switch. Also disclosed is an operating method including performing a DMA operation between any two nodes in a scale-up network using the scale-up switch and performing a load operation or a store operation between any two nodes in the scale-up network using the scale-up switch.

### BACKGROUND

The present disclosure relates to backend networks and, more particularly, to embodiments of a scale-up backend network and operating method.

Compute resources and, particularly, graphic processing units (GPUs) and accelerators in data center backend networks, have become the backbone of artificial intelligence (AI) and machine learning (ML) training and inference. As technology advances, these networks no longer simply provide connectivity. They are increasingly performance drivers for AI/ML processing, requiring new memory access solutions. For example, traditional remote memory access (RMA) techniques employed in these data center backend networks (e.g., within scale-up networks between nodes of a compute cluster (CC) or performance optimized datacenter (POD)) have become less than optimal due to an inability to keep up with the explosive growth in data and computational intensity associated with AI/ML processing. As a result, these data center backend networks may struggle to meet performance demands (e.g., processing speed specifications). Direct memory access (DMA) techniques may provide a solution for improved networking performance; however, currently DMA will not work between nodes over a scale-up network with the same address space.

### SUMMARY

Disclosed herein are embodiments of a data center backend network. The data center backend network can include multiple compute clusters (e.g., interconnected over a scale-out network). Each computer cluster can include a scale-up network. The scale-up network can include: a group of nodes; and a scale-up switch. The nodes can include network interface cards, respectively, and the scale-up switch in communication with those network interface cards. The network interface card of each node can include a subsystems block with a network infrastructure subsystem that supports both load and store operations and direct memory access operations between the nodes using the scale-up switch (i.e., over a scale-up network with the same address space).

Also disclosed herein are embodiments of a method of operating such a datacenter backend network. Specifically, the method can include accessing the data center backend network described above and performing various different types of memory access operations. For example, the method can include performing a direct memory access operation between any two nodes of the group using the scale-up switch. The method can further include performing a load operation and/or performing a store operation between any two nodes of the group using the scale-up switch.

It should be noted that all aspects, examples, and features of disclosed embodiments mentioned in the summary above can be combined in any technically possible way. That is, two or more aspects of any of the disclosed embodiments, including those described in this summary section, may be combined to form implementations not specifically described herein. The details of one or more implementations are set forth in the accompanying drawings and the description below. Other features, objects and advantages will be apparent from the description and drawings, and from the claims.

### BRIEF DESCRIPTION OF THE DRAWINGS

The present disclosure will be better understood from the following detailed description with reference to the drawings, which are not necessarily drawn to scale and in which:

FIG. 1A is a schematic diagram generally illustrating an end-to-end data center network including a data center backend network with a scale-out network between multiple compute clusters (CCs) and scale-up networks within the CCs, respectively;

FIG. 1B is a schematic diagram illustrating, in greater detail, each node within each scale-up network in the data center backend network of FIG. 1A; and

FIG. 1C is a schematic diagram illustrating, in greater detail, each network interface card (NIC) within each node of FIG. 1B;

FIG. 2 is a schematic diagram illustrating communication between NICs of different nodes over a scale-up switch during a load and store operation or a direct memory access operation;

FIGS. 3A-3B show a flow diagram illustrating aspects of an embodiment of a method of operating a data center backend network and, particularly, performing a load (FIG. 3A) and store (FIG. 3B) operation between two nodes using a scale-up switch;

FIG. 4 is a flow diagram illustrating aspects of an embodiment of a method of operating a data center backend network and, particularly, performing direct memory access (DMA) operation between two nodes using a scale-up switch; and

FIG. 5 is a schematic diagram illustrating an example of a hardware environment for implementing aspects of the disclosed data center backend network, methods and computer program products.

### DETAILED DESCRIPTION

As mentioned above, compute resources and, particularly, graphic processing units (GPUs) and accelerators in data center backend networks, have become the backbone of artificial intelligence (AI) and machine learning (ML) training and inference. As technology advances, these networks no longer simply provide connectivity. They are increasingly performance drivers for AI/ML processing, requiring new memory access solutions. For example, traditional remote memory access (RMA) techniques employed in these data center backend networks (e.g., within scale-up networks between nodes of a compute cluster (CC) or performance optimized datacenter (POD)) have become less than optimal due to an inability to keep up with the explosive growth in data and computational intensity associated with AI/ML processing. As a result, these data center backend networks may struggle to meet performance demands (e.g., processing speed specifications). Direct memory access (DMA) techniques may provide a solution for improved networking performance; however, currently DMA will not work between nodes over a scale-up network with the same address spaceIn view of the foregoing, disclosed herein are embodiments of a data center backend network including multiple compute clusters (CCs) (e.g., performance optimized data centers (PODS)), which are, for example, interconnected over a scale-out network. Each CC can include a scale-up network including a scale-up switch and a group of nodes. Each node can be a networked computer (e.g., a server or virtual machine) with components configured for performing various distributed, high-performance tasks for artificial intelligence (AI) and machine learning (ML) applications. Such components can include, but are not limited to, memory block(s) including, for example, high bandwidth memories (HBMs), compute unit(s) (each including one or more graphic processing units and/or accelerators), direct memory access controller(s), a host computer processing unit (CPU), and a scale-up network interface card (NIC). The NICs of the different nodes can be in communication with the scale-up switch and can each include a subsystems block including a network infrastructure subsystem configured to support (i.e., designed or customized to enable and facilitate) scale-up operations across the scale-up network using the scale-up switch. Such scale-up operations can include memory access operations including both conventional load and store operations and direct memory access (DMA) operations between any two nodes in the scale-up network (i.e., over a scale-up network with the same address space). Also disclosed herein are embodiments of an operating method including performing a DMA operation between any two nodes within the scale-up network using the scale-up switch and/or performing a load operation and/or a store operation between any two nodes within the scale-up network using the scale-up switch.

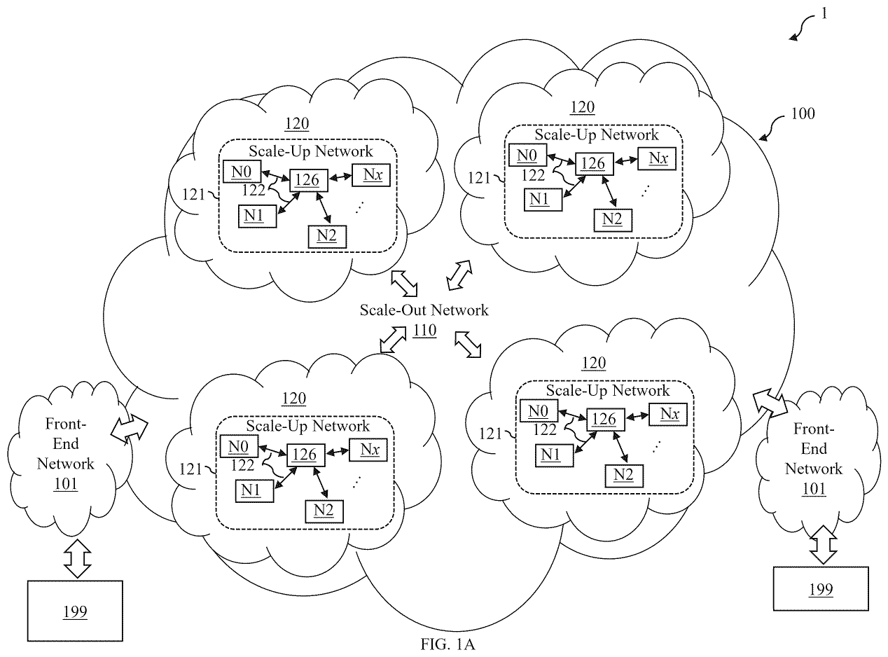

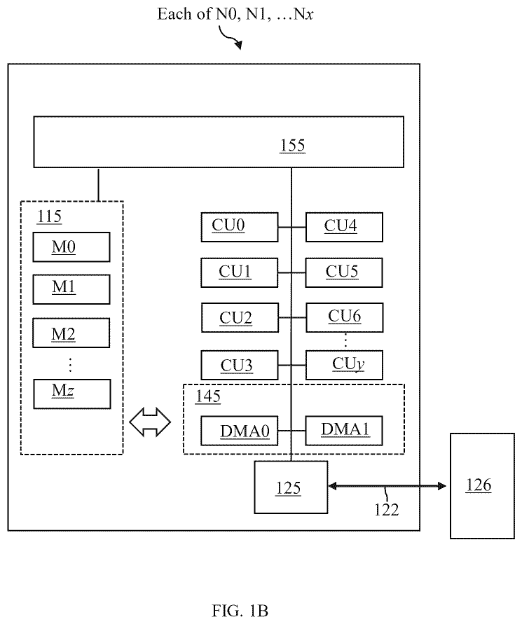

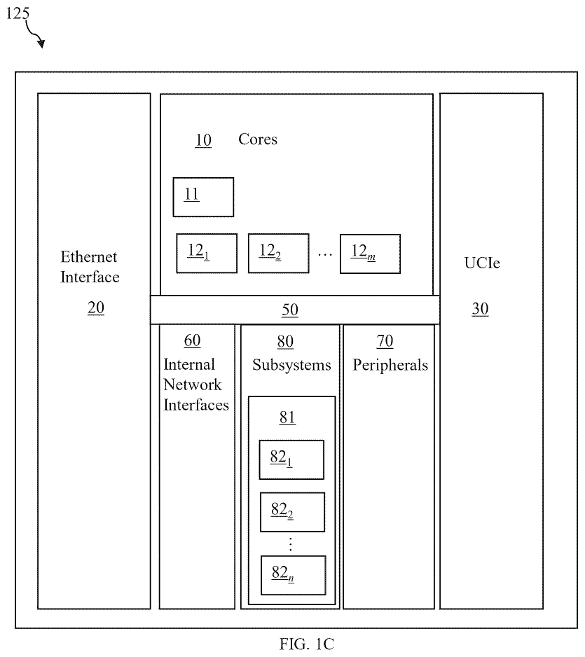

FIGS. 1A-1C are schematic diagrams illustrating disclosed embodiments of an end-to-end data center network 1. Specifically, FIG. 1A is a schematic diagram generally illustrating a data center network 1 including a data center backend network 100 with a scale-out network 110 between multiple compute clusters (CCs) 120 (e.g., performance optimized data centers (PODS)) and scale-up networks 121 within CCs 120, respectively. FIG. 1B is a schematic diagram illustrating, in greater detail, each node N1-Nx within each scale-up network 121 in data center backend network 100 of FIG. 1A. FIG. 1C is a schematic diagram illustrating, in greater detail, a network interface card (NIC) 125 and, particularly, a scale-up NIC within each node N1-Nx of FIG. 1B.

More specifically, FIG. 1A illustrates an example of an end-to-end data center network 1 for an AI or ML networking application. End-to-end data center network 1 can include a data center backend network 100 (also referred to herein as a graphic processing unit (GPU) fabric or AI accelerator fabric). End-to-end data center network 1 can also include front-end networks 101 through which users 199 can access data center backend network 100 to perform AI tasks (including ML tasks). Those skilled in the art will recognize that data center backend network 110 is a primary component providing high-performance inter-device communication for Al-driven data centers. Generally, data center backend network 110 can be configured to support the demands of distributed AI workloads (e.g., training and inference) including, but not limited to, distributed memory sharing, gradient aggregation for large language models, collective communications in multi-node AI training, managing memory access operations requiring guaranteed delivery, and providing precise congestion control, etc.

Data center backend network 100 can further be configured to provide quality-of-service specifications including, but not limited to, a guaranteed bandwidth (e.g., approximately 400/800 Gbps per device), low latency (e.g., around 2 microseconds (μs)), lossless transmission, and predictable performance under loaded conditions. Data center backend network 100 can include a scale-out network 110. This scale-out network can include a system of interconnected compute clusters (CCs) 120 (e.g., performance optimized datacenters (PODs)). Such CCs or PODs allow data centers to grow incrementally by adding new CCs or PODs. A scale-out network typically facilitates communication between CCs 120 (e.g., connecting together thousands of accelerators) and uses remote direct access memory (RDMA) for efficient data transfer across CCs 120. Generally, such scale-out networks are well known in the art. Thus, the details thereof have been omitted from the specification in order to allow the reader to focus on the salient aspects of the disclose embodiments (e.g., related to scale-up networks 121 with CCs 120, as discussed in greater detail below).

Within the scale-out network 110, each CC 120 (e.g., each POD) can include a scale-up network 121. Each scale-up network 121 can include a scale-up switch 126. Scale-up switch 126 can be, for example, an AI infrastructure scale-up switch (i.e., a switch compliant with any scale-up technology) such as Ultra Accelerator Link (UALink). Each scale-up network 121 can further include a group of nodes (N1-Nx), where each node N1-Nx in the group is in communication with scale-up switch 126 over a scale-up network interface 122 (e.g., a UALink interface). Thus, all nodes N1-Nx within scale-up network 121 of each CC 120 are connectable via scale-up switch 126. It should be understood that each scale-up network 121 can include three or more nodes. Furthermore, the total number of nodes N1-Nx within the different scale-up networks 121 in the different CCs 120 can be the same or different.

Referring to FIG. 1B, each node N1-Nx with a scale-up network 121 can be a networked computer (e.g., a server or virtual machine) and can include various interconnected components, which are configured to perform distributed, high-performance tasks for artificial intelligence (AI) and machine learning (ML) applications. The various node components described below and illustrated in FIG. 1B can be in communication over a system bus, or some other protocol suitable for data transfer therebetween.

The node components can include a host computer processing unit (CPU) 155. This host CPU 155 can be the primary CPU of the node. That is, it can generally be configured to manage data flow, process instructions, etc. within the node.

The node components can further include at least one memory block 115 including a group of memory circuits (M0-Mz). These memory circuits M0-Mz can be, for example, high bandwidth memories (HBMs). HBMs include, for example, high-performance, three-dimensional (3D)-stacked dynamic random access (DRAM) circuits. Such 3D-stacked DRAM circuits are typically designed for extremely fast data transfer rates, and relatively low power consumption and, thus, are suitable for use in AI/ML processors, GPUs, and networking equipment.

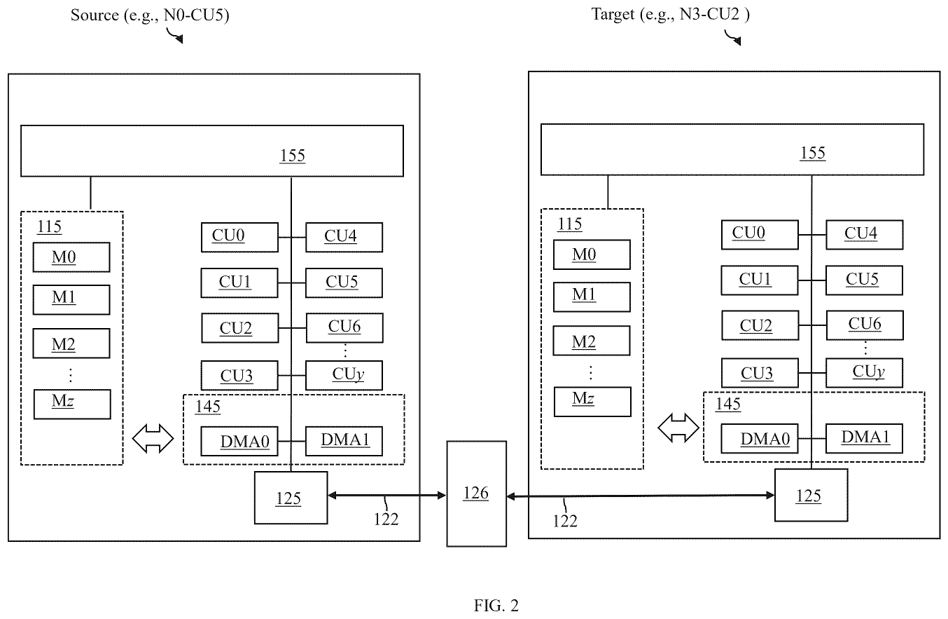

The node components can further include at least one compute unit (CU). Each CU can include at least one graphic processing unit (GPU) or accelerator for performing computations (e.g., in AI and/or ML applications). Those skilled in the art will recognize that a GPU generally refers to a specialized processor, which has a parallel architecture, and which is configured to rapidly process and render images, videos, etc. in AI and ML applications. For purposes of illustration, multiple compute units (CUs) (CU1-CUy) (also referred to as streaming multiprocessors (SMs)) are shown in FIG. 2.

The node components can further include a group 145 of one or more configurable direct memory access controller(s) (DMA0-DMA1). As discussed in greater detail below, a configurable DMA controller is a specialized component that will allow direct memory access without host CPU 155 processing.

The node components can further include a scale-up network interface card (NIC) 125. This NIC 125 can be, for example, network infrastructure chip or chiplet that is configured to support (i.e., designed or customized to enable and facilitate) scale-up networking operations. Referring to FIG. 1C, such a NIC 125 can include multiple blocks. These blocks can include but are not limited to: a cores block 10, an Ethernet interface block 20, a Universal Chiplet Interconnect Express (UCIe) block 30; a network-on-chip (NOC) fabric block 50; an internal network interfaces block 60; a peripherals block 70; and a subsystems block 80.

At least some of the blocks can include standard components found within a NIC. For example, cores block 10 can include one or more central processing unit (CPU) cores 11. Generally, in a networking environment, CPU cores can include the processors that perform computational tasks, etc. required networking device (e.g., switch, router, etc.) operation. For example, CPU core(s) execute instructions for managing data flow (e.g., packet processing, control plane tasks, data plane acceleration, parallel processing, etc.). Ethernet interface block 20 can include an Ethernet interface or medium (e.g., copper or fiber) to facilitate connecting the chiplet to an Ethernet network. Speed of the Ethernet interface or medium can be variable (e.g., depending on the networking application specifications) such as at 1G, 10G, 100G, 200G, 400G, 800G, etc. Internal network interfaces block 60 can include the Ethernet physical (Phys) and media access control (MAC) layers that are compliant with IEE 802.3 standards and integrated, for example, into a network interface card (NIC), Ethernet switch, etc. UCIe block 30 refers to an open industry standard that defines an interface for chiplet-to-chiplet connections within a single IC package. Peripherals block 70 can include memories and buffers. NOC fabric block 50 can include an interconnect infrastructure including dedicated, high-bandwidth routing paths (e.g., routers and links) to provide communication between and, particularly, to move data efficiently between all of the various blocks (and components therein) within NIC 125.

Subsystems block 80 can include a networking infrastructure subsystem 81, which includes multiple subsystem components 82₁-82ₙ and which is configured to support (i.e., designed or customized to enable and facilitate) scale-up operations between nodes N1-Nx across the scale-up network 121. These scale-up operations can specifically include memory access operations including both conventional load and store operations and direct memory access (DMA) operations between any two nodes in the scale-up network (i.e., over a scale-up network with the same address space).

Subsystem components 82₁-82ₙ within network infrastructure subsystem 81 can include, but are not limited to, one or more of any of: a host-side AI accelerator-side network interface; an AI infrastructure scale-up switch (which is compliant with any scale-up technology, such as Ultra Accelerator Link (UALink), Scale-Up Ethernet (SUE), Ethernet for Scale-Up Networking (ESUN), etc.); an AI infrastructure scale-out switch (which is compliant with any scale-out technology, such as Ultra Ethernet Consortium (UEC), etc.); an AI infrastructure scale-across switch (which is compliant with any scale-across technology); an AI infrastructure in-network collective (INC) switch; an Ethernet Data Plane for industrial or automotive networking applications; an Ethernet Switch for industrial or automotive networking applications; an Ethernet Router for industrial or automotive networking applications; an inline real time network packet processor; an inline network security processor (e.g., a transport layer security (TLS) processor); an inline faster and dedicated control plane packet processor; an inline faster telemetry processor; and an inline faster application processor (e.g., a network management processor (NMI)). It should be understood that the list provided above is not exhaustive and any other, now known or subsequently developed, subsystem component suitable for supporting scale-up networking functionality could be employed.

It should be noted that in addition to the CPU core(s) 11 mentioned above cores block 10 may also include one or more softcores 12₁-12ₘ (also referred to herein as optimized softcores), which are each specifically optimized for improving performance, power and/or area (PPA) of at least one networking function. Those skilled in the art will recognize that a softcore refers to a set of instructions (code) synthesized into programmable logic (e.g., a field-programmable gate array (FPGA)). Because a softcore is code-based (i.e., a set of instructions), it can be customized for a specific networking function or multiple different networking functions. Generally, the optimized softcores include sets of instructions (code) directed to a specific networking function or multiple networking functions and optimized (i.e., specifically designed) to improve performance, power and/or area (PPA) in a networking environment. Such optimized softcores can include, but are not limited to any of the following: in-order to high-performance out-of-order scalable multi-core; a high-efficiency multi-threading core; a high-level operating system (HLOS) core; a real-time operating system (RTOS) core; a core optimized for faster forwarding plane programming; a core optimized for inline processing including packet processing; a core optimized for control plane processing; a core optimized for telemetry processing; a core optimized for management processing; a core optimized for remote procedure call processing; a core optimized for network management interface processing; a core optimized for security; a core optimized for in-network collective processing; a core optimized to run any of applications and agents of the applications; and a core optimized for application-to-network stack interface processing. It should be noted that each of the above-mentioned optimized softcores are directed to one specific networking function. However, it should be understood any two or more of the above-mentioned optimized softcores could instead be combined into a single softcore (i.e., a single set of instructions) directed to two or more specific networking functions.

As mentioned above, each node N1-Nx in a group (i.e., in a scale-up network 121 in a CC 120) is in communication with scale-up switch 126 over a scale-up network interface 122 (e.g., a UALink interface). As illustrated in FIG. 1B, for each node a scale-up network interface 122 couples the NIC 125 and, particularly, network infrastructure subsystem 81 thereof and scale-up switch 126. A network infrastructure subsystem 81, as described above, may be configured to support (i.e., designed or customized to enable and facilitate) the performance of fast load and store operations and also facilitate the performance of fast and efficient DMA operations within the same address space.

Also disclosed herein are embodiments of a method of operating the datacenter backend network 1 of FIGS. 1A-1C and, particularly, performing such load and store operations and DMA operations between nodes within the same scale-up network 121 within a CC 120. These two memory access operations within a scale-up network 121 will be described below between a source (including a specific node and specific compute unit therein) that is requesting data and a target (including a specific node and specific compute unit therein) from which the data is being requested. For purposes of illustration, the source can be compute unit-5 of node-0 (N0-C5) and the target can be compute unit-2 of node-3 within the same scale-up network 121 of a given CC 120, as illustrated in FIG. 2. Specifically, the method can include accessing the data center backend network described above and performing a direct memory access operation and/or a load and store operation between any two nodes of the group using the scale-up switch.

Generally, the disclosed method embodiments can include accessing a data center backend network 1, as described in detail above and illustrated in FIGS. 1A-1C. The method can include performing a load operation and/or a store operation between any two nodes (e.g., N0 and N3, as shown in FIG. 2) in the same scale-up network 121 using scale-up switch 126. This method can further include performing a direct memory access operation between any two nodes in the same scale-up network 121 (and even the same two nodes, such as N0 and N3, as used for the load and store operation).

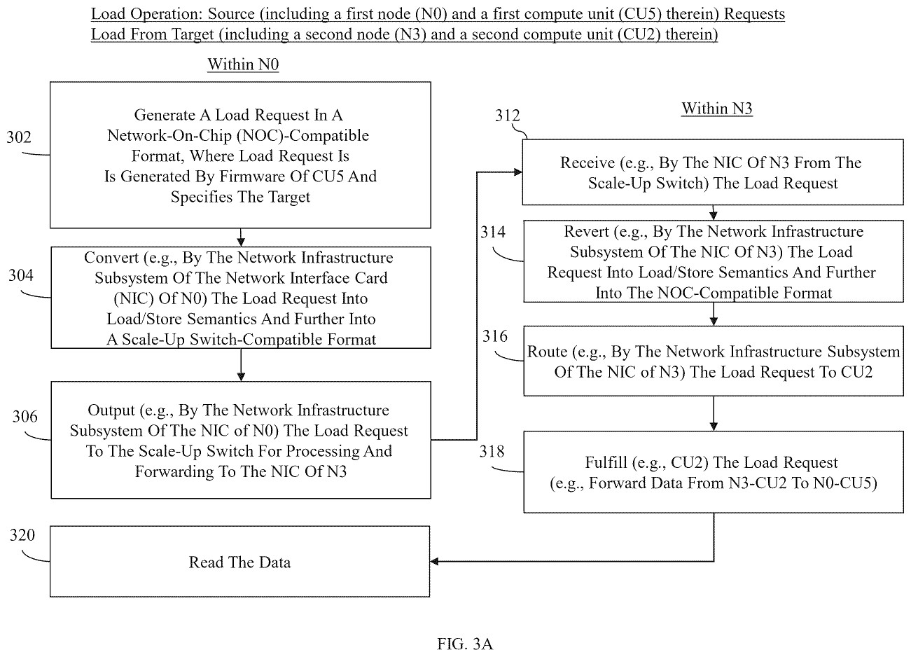

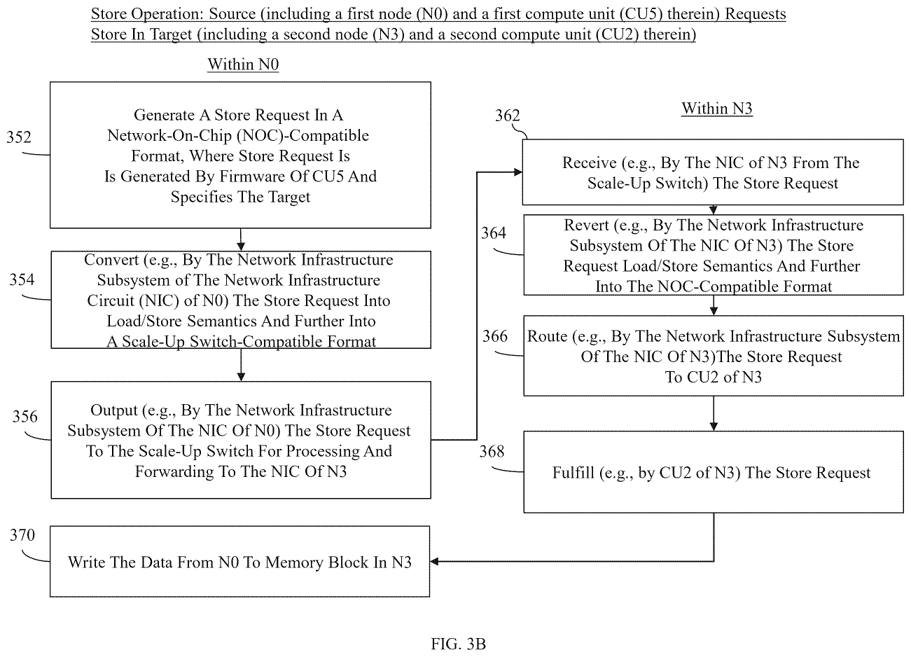

FIGS. 3A-3B show a flow diagram illustrating performance of the load operation (FIG. 3A) and performance of the store operation (FIG. 3B). As discussed in greater detail below, a load operation can be performed between a source, including N0 (which is referred to herein as the first node) and CU2 of N0 (which is referred to herein as the first compute unit), requesting a load and a target including N3 (which is referred to herein as the second node) and CU2 (which is referred to herein as the second compute unit) from which the load is being requested (i.e., from which data is to be read). Similarly, a store operation can be performed between a source, including N0 (which is referred to herein as the first node) and CU2 of N0 (which is referred to herein as the first compute unit), requesting storage of data and a target including N3 (which is referred to herein as the second node) and CU2 (which is referred to herein as the second compute unit) for the store request (i.e., where data storage is desired). These load and store operations can be performed without processing by host CPU 155 from either first node N0 or the second node N3

Specifically, referring to FIG. 3A in conjunction with FIGS. 1A-1C and 2, performance of the load operation can be initiated within the first node N0 and can include generating a load request (see process 302). This load request can specifically be generated at process 302 by firmware of first compute unit CU5 in a network-on-chip (NOC)-compatible format. That is, it can be in a format that is compatible with the NOC 50 of NIC 125, such as in a Coherent Hub Interface (CHI) format or some other suitable NOC-compatible format. Additionally, the load request can designate the target of the load request (i.e., the second node N3 and second compute unit CU2). Once generated, the load request can be output to, and received by, the NOC 50 of NIC 125 of first node N0. The NOC 50 can forward the load request to network infrastructure subsystem 81 of NIC 125, where it is decoded and converted into load/store semantics and then further into a scale-up switch-compatible format (see process 304). For example, the load request received by the network infrastructure subsystem 81 can be decoded and converted into load/store semantics via libfabric application programming interfaces (APIs). The network infrastructure subsystem 81 can further create a scale-up switch protocol level interface flow control unit (FLIT) (e.g., a UALink Protocol Level Interface (UPLI) FLIT). In this format, the load request can be output (e.g., streamed) via a scale-up network interface 122 to scale-up switch 126 (e.g., a UALink switch) for processing and forwarding to second node N3 (see process 306).

Scale-up switch 126 can, for example, receive the load request via the scale-up network interface 122, convert it to a UPLI FLIT, and output it (e.g., steam it) via another scale-up network interface 122 to second node N3.

The load request can be received by the NIC 125 of second node N3 (see process 312). At this point, performance of the load operation can further include reverting (e.g., by network infrastructure subsystem 81 within the NIC 125 of second node N3) the load request back into load/store semantics (e.g., via libfabric APIs) and further back into the NOC-compatible format (see process 314). It can then be routed (e.g., by the network infrastructure subsystem 81 via NOC 50 of the NIC 125 of second node N3) to the second compute unit CU2 (see process 316). Second compute unit CU2 can receive and process the load request (e.g., fulfill the load request by causing the requested data to be forwarded back to the source and read (see processes 318-320).

Referring to FIG. 3B in conjunction with FIGS. 1A-1C and 2, performance of the store operation can be similar. That is, performance of a store operation can be initiated within the first node N0 and can include generating a store request (see process 352). This store request can specifically be generated at process 352 by firmware of first compute unit CU5 in a network-on-chip (NOC)-compatible format. That is, it can be in a format that is compatible with the NOC 50 of NIC 125, such as in a Coherent Hub Interface (CHI) format or some other suitable NOC-compatible format. Additionally, the store request can designate the target of the store request (i.e., the second node N3 and second compute unit CU2). Once generated, the store request can be output to, and received by, the NOC 50 of NIC 125 of first node N0. The NOC 50 can forward the store request to network infrastructure subsystem 81 of NIC 125, where it is decoded and converted into load/store semantics and then further into a scale-up switch-compatible format (see process 354). For example, the store request received by the network infrastructure subsystem 81 can be decoded and converted into load/store semantics via libfabric application programming interfaces (APIs). The network infrastructure subsystem 81 can further create a scale-up switch protocol level interface flow control unit (FLIT) (e.g., a UALink Protocol Level Interface (UPLI) FLIT). In this format, the store request can be output (e.g., streamed) via a scale-up network interface 122 to scale-up switch 126 (e.g., a UALink switch) for processing and forwarding to second node N3 (see process 356).

Scale-up switch 126 can, for example, receive the store request via the scale-up network interface 122, convert it to a UPLI FLIT, and output it (e.g., steam it) via another scale-up network interface 122 to second node N3.

The store request can be received by the NIC 125 of second node N3 (see process 362). At this point, performance of the store operation can further include reverting (e.g., by network infrastructure subsystem 81 within the NIC 125 of second node N3) the store request back into load/store semantics (e.g., via libfabric APIs) and further back into the NOC-compatible format (see process 364). It can then be routed (e.g., by the network infrastructure subsystem 81 via NOC 50 of the NIC 125 of second node N3) to the second compute unit CU2 (see process 366). Second compute unit CU2 can receive and process the store request (e.g., fulfill the store request by causing data from N0 to be written to a memory block in N3 (see process 368). Confirmation of fulfillment of the write operation can be received by N0 (see process 370).

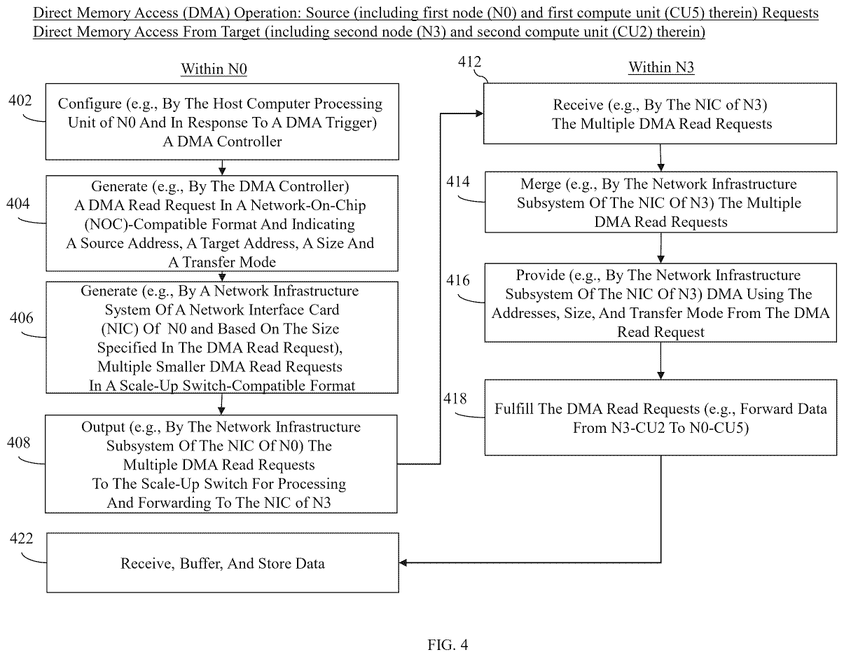

FIG. 4 is a flow diagram illustrating performance of a direct memory access (DMA) operation between two nodes using a scale-up switch. As discussed in greater detail below, this DMA operation can be performed between a source, including N0 (which is referred to herein as the first node) and CU2 of N0 (which is referred to herein as the first compute unit), requesting DMA and a target including N3 (which is referred to herein as the second node) and CU2 (which is referred to herein as the second compute unit) from which the direct memory access is being requested. As noted below, this DMA operation will be performed at least with some processing by host CPU 155 from first node N0.

Specifically, referring to FIG. 4 in conjunction with FIGS. 1A-1C and 2, performance of the DMA operation can be initiated in first node N0 in response to a DMA trigger. This DMA trigger could be software triggered (i.e., in caused by specific instructions to perform the DMA operation). Alternatively, the DMA trigger could be hardware triggered (e.g., by a smart hardware engine or AI-driven computing components). Once the DMA operation is triggered, a DMA controller (e.g., DMA0 within first node N0) can be configured (e.g., by the host CPU 155 of first node N0) (see process 402). Configuring of the DMA controller can include, for example, setting a source address, a target address, a size and a transfer mode and further enabling a DMA request. Next, a DMA read request can be generated (e.g., by the DMA controller) (see process 404). The DMA read request can include the source address, a target address, a size and a transfer mode and can be in NOC-compatible format. The DMA read request can further be forwarded along with remote compute unit information via the NOC 50 of NIC 125 to the network infrastructure subsystem 81. Multiple smaller DMA read requests can then be generated (e.g., by the network infrastructure subsystem 81) (see process 406). These multiple DMA read requests can be generated based on the size noted in the original DMA read request and a maximum allowable read request size. For example, if a maximum allowable read request size is 640 Bytes (B) and the size noted in the original DMA read request is 1280B, then then the original DMA read request will be divided into two smaller DMA read requests (each with a size of 640B). Additionally, these smaller DMA read requests can be converted (e.g., by the network infrastructure subsystem 81) into a scale-up switch-compatible format. For example, the network infrastructure subsystem 81 can further create scale-up switch protocol level interface flow control units (FLITs) (e.g., a UALink Protocol Level Interface (UPLI) FLITs) for the read requests. The DMA read requests can then be output (e.g., streamed) via a scale-up network interface 122 to scale-up switch 126 (e.g., a UALink switch) for processing and forwarding to second node N3 (see process 408).

Scale-up switch 126 can, for example, receive the DMA read requests via the scale-up network interface 122, convert them into UPLI FLITs, and output them (e.g., steam them) via another scale-up network interface 122 to second node N3.

The DMA read requests can be received by the NIC 125 of second node N3 (see process 412). At this point, performance of the DMA operation can further include merging (e.g., by network infrastructure subsystem 81 within the NIC 125 of second node N3) the multiple read requests back into a single read request and further back into the NOC-compatible format (see process 414). It can then be routed (e.g., by the network infrastructure subsystem 81 via NOC 50 of the NIC 125 of second node N3) to the second compute unit CU2 for providing DMA (e.g., using the addresses, size, and transfer mode noted in the DMA read request) and for fulling the DMA read requests (e.g., causing the requested data to be forwarded back to the source (see processes 416-418). Data forwarded back to the source can be received, buffered and stored in a memory block 115 of first node N0 (e.g., in a least one of the memory circuits M0-Mz of the first node N0) (see process 422).

The above-described data center backend network 1 (e.g., as illustrated in FIGS. 1A-1C) and operating method thereof effectively provide an optimized and faster remote memory access across AI/ML compute using direct memory access (DMA) over a scale-up backend network infrastructure that utilizes a customizable network subsystem. These embodiments leverage the complementary strengths of optimized remote accelerator's memory access and network subsystem solutions and are designed to adapt seamlessly to a wide range of application needs, from training large-scale models to handling diverse industrial and automotive workloads. These embodiments offer a robust dynamic control and data plane framework for building scalable and flexible network infra subsystems for remote accelerator's memory access that can evolve with future demands of AI applications. These embodiments also offer a unified, simple single pane of glass management of all different components of flexible network infrastructure (e.g., using the optimized softcores discussed above). This enables easier operation, administration, and maintenance of network infrastructure for various applications. The embodiments further ensure flexibility, scalability, and performance in remote accelerator memory access (same address space) catering to the unique data and network traffic characteristics of diverse AI/ML applications.

By addressing different load-store and DMA functionalities in one system on-chip hardware solution using the network subsystem 81 of the NIC 125 in each node in a scale-up network 121, this customizable and interoperable solution sets the foundation for the next generation of AI network infrastructure for different use cases. Thus, the disclosed embodiments provide significant advantages in simplifying network operations and enhancing overall operational efficiency in remote memory access for AI Infra. A unified plane streamlines monitoring, configuration, and orchestration processes, reducing the operational overhead associated with managing separate solutions. This integration enables consistent policy enforcement, accelerates troubleshooting, and enhances real-time adaptability to dynamic workloads. Furthermore, a single pane of glass management and unified control plane also fosters better resource utilization, improved security, and scalability by offering a cohesive framework supporting seamless integration of diverse applications.

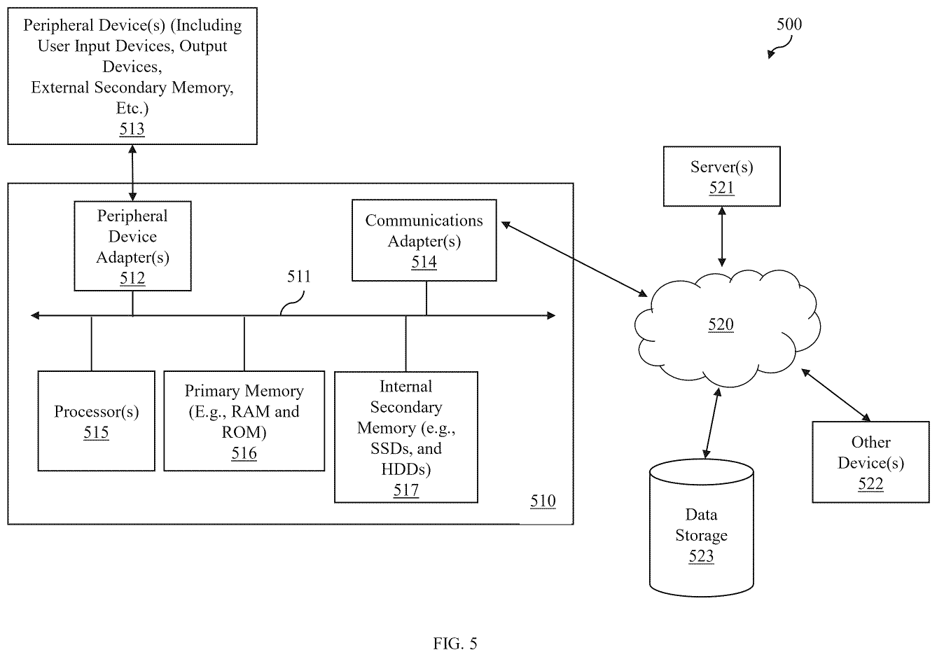

Aspects of the disclosed embodiments may be implemented in hardware and/or software (e.g., as computer program product). An illustrative hardware environment 500 for implementing aspects of the disclosed embodiments is depicted in FIG. 5. Generally, the hardware environment can include at least one computing device 510 (also referred to herein as a computer). Computer 510 can be, for example, a desktop, laptop, tablet, mobile computing device, etc. Computer 510 can include at least one bus 511. Bus 511 can be connected to various other components of computer 510 and can be configured to facilitate communication between those components.

Computer 510 can include various adapters. The adapters can include one or more peripheral device adapters 512, which are configured to facilitate communications between one or more peripheral devices 513, respectively, and bus 511. Peripheral devices 513 can include user input devices configured to receive user inputs. User input devices can include, but are not limited to, a keyboard, a mouse, a microphone, a touchpad, a touchscreen, a stylus, bio-sensor, a scanner, or any other type of user input device. The peripheral devices 513 can also include additional input devices, such as external secondary memory devices (as discussed in greater detail below). Peripheral devices 513 can also include output devices. The output devices can include, but are not limited to, a printer, a monitor, a speaker, or any other type of computer output device. The adapters can include one or more communications adapters 514 (also referred to herein as a computer network adapters), which are configured to facilitate communications between computer 510 and one or more communications networks 520 (e.g., a wide area network (WAN), a local area network (LAN), the internet, a cellular network, a Wi-Fi network, etc.). Such network(s) 520 can, in turn, facilitate communication between computer 510 and other system components on the network: remote server(s) 521, other device(s) 522 (e.g., computers, laptops, tablets, mobile phones, etc.), remote data storage 523, etc.

Computer 510 can further include at least one processor 515 (also referred to herein as a central processing units (CPU)). Optionally, each CPU 515 can include a CPU cache. Each CPU 515 can be configured to read and execute program instructions.

Computer 510 can further include memory and, particularly, computer-readable storage mediums. The memory can include primary memory 516 and secondary memory. Primary memory 516 can include, but is not limited to, random access memory (RAM) (e.g., volatile memory employed during execution of program operations) and read only memory (ROM) (e.g., non-volatile memory employed during start-up). The RAM can include, but is not limited to, dynamic random access memory (DRAM), static random access memory (SRAM), or any other suitable type of RAM. The ROM can include, but is not limited to, erasable programmable read only memory (EPROM), flash memory, electronically erasable programmable read only memory (EEPROM), programmable read only memory (PROM), or any other suitable type of ROM. The secondary memory can be non-volatile. The secondary memory can include internal secondary memory 517, such as internal solid state drive(s) (SSD(s)) and/or internal hard disk drive(s) (HDD(s), installed within computer 510 and connected to bus 511. The secondary memory can also include external secondary memory connected to or otherwise in communication with the computer 510 (e.g., peripheral devices). The external secondary memory can include, for example, external/portable SSD(s), external/portable HDD(s), flash drive(s), thumb drives, compact disc(s) (CD(s)), digital video disc(s) (DVD(s)), network-attached storage (NAS), storage area network (SAN), or any other suitable non-transitory computer-readable storage media connected to or otherwise in communication with the computer 510. The different functions of primary and secondary memory are well known in the art and, thus, the details thereof have been omitted from this specification in order to allow the reader to focus on the salient aspects of the disclosed embodiments.

In some embodiments, program instructions for performing the disclosed method or a portion thereof, as described above, can be embodied in (e.g., stored in) secondary memory accessible by computer 510. When the program instructions are to be executed (e.g., in response to user inputs to computer 510), required information (e.g., the program instructions and other data) can be loaded into the primary memory (e.g., stored in RAM). CPU 515 can read the program instructions and other data from the RAM and can execute the program instructions. In other embodiments, a client-server model can be employed. In this case, computer 510 can be a client and a remote server 521 in communication with computer 510 over a network 520 can provide, to the client, a service including execution of program instructions for performing the disclosed method or a portion thereof, as described above, in response to user inputs to computer 510.

It should be understood that the terminology used herein is for the purpose of describing the disclosed structures and methods and is not intended to be limiting. For example, as used herein, the singular forms “a,” “an,” and “the” are intended to include the plural forms as well, unless the context clearly indicates otherwise. Additionally, as used herein, the terms “comprises,” “comprising,” “includes,” and/or “including” specify the presence of stated features, integers, steps, operations, elements, and/or components, but do not preclude the presence or addition of one or more other features, integers, steps, operations, elements, components, and/or groups thereof. Furthermore, as used herein, terms such as “right,” “left,” “vertical,” “horizontal,” “top,” “bottom,” “upper,” “lower,” “under,” “below,” “underlying,” “over,” “overlying,” “parallel,” “perpendicular,” etc., are intended to describe relative locations as they are oriented and illustrated in the drawings (unless otherwise indicated) and terms such as “touching,” “in direct contact,” “abutting,” “directly adjacent to,” “immediately adjacent to,” etc., are intended to indicate that at least one element physically contacts another element (without other elements separating the described elements). The term “laterally” is used herein to describe the relative locations of elements and, more particularly, to indicate that an element is positioned to the side of another element as opposed to above or below the other element, as those elements are oriented and illustrated in the drawings. For example, an element that is positioned laterally adjacent to another element will be beside the other element, an element that is positioned laterally immediately adjacent to another element will be directly beside the other element, and an element that laterally surrounds another element will be adjacent to and border the outer sidewalls of the other element. The corresponding structures, materials, acts, and equivalents of all means or step plus function elements in the claims below are intended to include any structure, material, or act for performing the function in combination with other claimed elements as specifically claimed.

The descriptions of the various disclosed embodiments have been presented for purposes of illustration but are not intended to be exhaustive or limiting. Many modifications and variations will be apparent to those of ordinary skill in the art without departing from the scope and spirit of the disclosed embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A data center backend network comprising:
multiple compute clusters, wherein each compute cluster includes a scale-up network including:
a group of nodes, wherein the nodes include network interface cards, respectively; and
a scale-up switch in communication with the network interface cards, wherein the network interface cards are scale-up network interface cards and wherein each network interface card includes a subsystems block with a network infrastructure subsystem that supports direct memory access operations and load and store operations between the nodes using the scale-up switch.

2. The data center backend network of claim 1, wherein each node includes:
the network interface card;
at least one memory block;
at least one compute unit;
at least one direct memory access controller; and
a host computer processing unit in communication with the network interface card, the at least one memory block, the at least one compute unit, and the at least one direct memory access controller.

3. The data center backend network of claim 2, wherein the at least one memory block includes a high bandwidth memory (HBM).

4. The data center backend network of claim 2, wherein the at least one compute unit includes at least one of a graphics processing unit and an accelerator.

5. The data center backend network of claim 1, wherein the load and store operations are performed without host computer processing unit processing.

6. The data center backend network of claim 1, wherein the direct memory access operations are performed with host computer processing unit configuring of a direct memory access controller.

7. The data center backend network of claim 1, wherein each network interface card
includes multiple blocks including:
the subsystems block;
a cores block;
an Ethernet interface block;
a Universal Chiplet Interconnect Express (UCIe) block;
an internal network interfaces block;
a peripherals block; and
a network-on-chip (NOC) fabric block providing communication between the multiple blocks.

8. The data center backend network of claim 1, wherein the network infrastructure subsystem includes one or more of any of:
a host-side artificial intelligence accelerator-side network interface;
an artificial intelligence infrastructure scale-up switch;
an artificial intelligence infrastructure scale-out switch;
an artificial intelligence infrastructure scale-across switch;
artificial intelligence infrastructure in-network collective (INC) switch;
an Ethernet Data Plane;
an Ethernet Switch;
an Ethernet Router;
an inline network packet processor;
an inline network security processor;
an inline control plane packet processor;
an inline telemetry processor; and
an inline application processor.

9. A method comprising:
accessing a data center backend network including multiple compute clusters,
wherein each compute cluster includes a scale-up network including:
a group of nodes, wherein the nodes include network interface cards, respectively; and
a scale-up switch in communication with the network interface cards, wherein the network interface cards are scale-up network interface cards and wherein each network interface card includes a subsystems block with a network infrastructure subsystem that supports direct memory access operations and load and store operations between the nodes using the scale-up switch; and
performing a direct memory access operation between any two nodes of the group; and
performing at least one of a load operation and a store operation between any two nodes of the group.

10. The method of claim 9, wherein each node includes:
the network interface card;
at least one memory block;
at least one compute unit;
at least one direct memory access controller; and
a host computer processing unit in communication with the network interface card, the at least one memory block, the at least one compute unit, and the at least one direct memory access controller.

11. The method of claim 10, wherein the at least one memory block includes a high bandwidth memory (HBM) and wherein the at least one compute unit includes at least one of a graphics processing unit and an accelerator.

12. The method of claim 10, wherein each network interface card includes multiple blocks
including:
the subsystems block;
a cores block;
an Ethernet interface block;
a Universal Chiplet Interconnect Express (UCIe) block;
an internal network interfaces block;
a peripherals block; and
a network-on-chip (NOC) fabric block providing communication between the multiple blocks.

13. The method of claim 12, wherein the performing of the direct memory access operation includes configuring of a direct memory access controller by a host computer processing unit.

14. The method of claim 12, wherein the two nodes include a first node and a second node
and wherein the performing of the direct memory access operation includes, within the first node:
in response to a direct memory access trigger in any one of software and hardware of the first node, configuring of the direct memory access controller by the host computer processing unit;
generating, by the direct memory access controller of the first node, a direct memory access read request in a network-on-chip (NOC)-compatible format;
generating, by the network infrastructure subsystem of the first node and based on the direct memory access read request in the NOC-compatible format, multiple direct memory access read requests in a scale-up switch-compatible format;
outputting, by the network infrastructure subsystem of the first node, the multiple direct memory access read requests in the scale-up switch-compatible format to the scale-up switch for processing and forwarding to the network interface card of the second node;
buffering, by the network infrastructure subsystem of the first node, data received from the second node during fulfilment of the multiple direct memory access read requests; and
storing the data in the at least one memory block.

15. The method of claim 14,
wherein the configuring of the direct memory access controller includes setting a source address, a target address, a size and a transfer mode, and
wherein the generating of the multiple direct memory access read requests in the scale-up switch-compatible format is performed based on the size.

16. The method of claim 15, wherein the performing of the direct memory access operation
further includes, within the second node:
receiving, by the network infrastructure subsystem of the second node, the multiple direct memory access read requests in the scale-up switch-compatible format;
merging, by the network infrastructure subsystem of the second node, the multiple direct memory access read request back into a single direct memory access read request; and
providing direct memory access.

17. The method of claim 12, wherein the performing of the at least one of the load operation and the store operation is performed without processing by a host computer processing unit.

18. The method of claim 12, wherein the two nodes include a first node and a second node
and wherein the performing of a load operation includes, within the first node:
generating, by firmware of a first compute unit of the first node, a load request in a network-on-chip (NOC)-compatible format and designating a second compute unit of the second node;
receiving, by the network interface card of the first node, the load request in the NOC-compatible format;
converting, by the network infrastructure subsystem of the first node, the load request into a scale-up switch-compatible format; and
outputting, by the network infrastructure subsystem of the first node, the load request in the scale-up switch-compatible format to the scale-up switch for processing and forwarding to the network interface card of the second node.

19. The method of claim 18, wherein the performing of the load operation further includes,
within the second node:
reverting, by the network infrastructure subsystem of the second node, the load request in the scale-up switch-compatible format back into the NOC-compatible format;
routing, by the network infrastructure subsystem of the second node, the load request in the NOC-compatible format to the second compute unit designated in the load request.

20. The method of claim 9, wherein the network infrastructure subsystem includes one or more of any of:
a host-side artificial intelligence accelerator-side network interface;
an artificial intelligence infrastructure scale-up switch;
an artificial intelligence infrastructure scale-out switch;
an artificial intelligence infrastructure scale-across switch;
artificial intelligence infrastructure in-network collective (INC) switch;
an Ethernet Data Plane;
an Ethernet Switch;
an Ethernet Router;
an inline network packet processor;
an inline network security processor;
an inline control plane packet processor;
an inline telemetry processor; and
an inline application processor.
